(19) United States
(12) Patent Application Publication
(10) Pub. No.: US 2011/0231575 A1
(43) Pub. Date: Sep. 22, 2011

(54) SYSTEMS AND METHODS FOR INTERMEDIATION OF THE DELIVERY OF AN INTERNET SERVICE

(76) Inventor: Tom C. Tovar, San Francisco, CA (US)

(21) Appl. No.: 12/896,819

(22) Filed: Oct. 1, 2010

Related U.S. Application Data
(63) Continuation-in-part of application No. 12/727,001, filed on Mar. 18, 2010.
(60) Provisional application No. 61/370,556, filed on Aug. 4, 2010.

(51) Int. Cl. G06F 15/16

(52) U.S. Cl. 709/246

(57) ABSTRACT

Systems and methods for mediating Internet service are provided herein. According to some exemplary embodiments a method for mediating Internet service includes executing instructions stored in a memory by a processor to selectively apply an intermediation policy to the Internet service, the intermediation policy including information indicative of targeted Internet content, and modify at least a portion of targeted Internet content before delivery of the targeted Internet content via the Internet service.

### CROSS-REFERENCE TO RELATED APPLICATIONS

This nonprovisional patent application is a continuation-in-part application that claims the priority benefit of U.S. patent application Ser. No. 12/727,001 filed on Mar. 18, 2010, titled “Internet Mediation,” and provisional U.S. Patent Application Ser. No. 61/370,556, filed on Aug. 4, 2010, titled “Internet Mediation Applications,” which are hereby incorporated by reference in their entirety.

### FIELD OF THE INVENTION

The present invention relates generally to mediating the delivery of an Internet service, and more specifically, but not by way of limitation, to systems and methods that selectively apply an intermediation policy to the Internet service and modify at least a portion of targeted Internet content before delivery of the targeted Internet content via the Internet service.

### SUMMARY OF THE INVENTION

According to exemplary embodiments, the present invention provides methods for mediating the delivery of Internet service including executing instructions stored in a memory by a processor to selectively apply an intermediation policy to the Internet service, the intermediation policy including information indicative of targeted Internet content, and modify at least a portion of targeted Internet content before delivery of the targeted Internet content via the Internet service.

According to other exemplary embodiments, the present invention is directed to systems for intermediation an Internet service delivered, the systems including a memory for storing an intermediation policy application and a processor for executing instructions to selectively apply an intermediation policy to the Internet service, the intermediation policy including information indicative of targeted Internet content, and modify at least a portion of targeted Internet content before delivery of the targeted Internet content via the Internet service.

According to additional exemplary embodiments, the present invention is directed to a computer readable storage medium having a program embodied thereon, the program executable by a processor in a computing system to perform a method for mediating the delivery of Internet service, the method including executing instructions stored in a memory by a processor to selectively apply an intermediation policy to the Internet service, the intermediation policy including information indicative of targeted Internet content, and modify at least a portion of targeted Internet content before delivery of the targeted Internet content via the Internet service.

### BRIEF DESCRIPTION OF THE DRAWINGS

FIG. 1 is an exemplary architecture of an intermediation policy application in accordance with various embodiments of the present invention.

FIG. 2 is a flow chart of an exemplary method for creating and applying an intermediation policy to an Internet service.

FIG. 3 is an exemplary representation of a web page for subscribing to the intermediation policy application.

FIG. 4 is an exemplary representation of a web page such as a configuration drawer for creating and/or editing an intermediation policy.

FIG. 5 is a block diagram of a DNS network arrangement in accordance with various embodiments of the present invention.

FIG. 6 is a block diagram of an exemplary system for providing variable content control for Internet user in accordance with various embodiments of the present invention.

FIG. 7 is a block diagram of an exemplary system for providing notifications regarding Internet access in accordance with various embodiments of the present invention.

### DETAILED DESCRIPTION OF EXEMPLARY EMBODIMENTS

While this invention is susceptible of embodiment in many different forms, there is shown in the drawings and will herein be described in detail several specific embodiments with the understanding that the present disclosure is to be considered as an exemplification of the principles of the invention and is not intended to limit the invention to the embodiments illustrated. According to exemplary embodiments, the present technology is directed to systems and methods for intervening the delivery of an Internet service to one or more computing systems operatively coupled to a common network or location, such as a home, business or campus using the Internet service. More specifically, the systems and methods selectively apply an intermediation policy to the Internet service to mediate the delivery of the Internet service by modifying at least a portion of targeted Internet content. It will be understood that the intermediation policy may include information indicative of targeted Internet content.

Rather than preventing access to targeted Internet content by way of blocking or redirecting users away from targeted content, the methods and systems of the present invention may translate at least a portion of the targeted Internet content from a first language to a second language. The systems and methods may then deliver the modified Internet content to the one or more computing systems. The systems and methods create a humorous or whimsical effect, rather than a more blunt or direct effect created by blocking the targeted Internet content.

Generally speaking, an administrator may create and enforce intermediation polices for one or more end users that utilize computing systems coupled to an Internet service via the Internet connection delivered to a particular location, such as a residence or place of business. The term “administrator” may include not only individuals, such as parents, but also any individual who desires to create and enforce intermediation policies regarding the Internet service. It will be understood that an administrator may also be an end user, although end users who are not also administrators may create or apply intermediation policies only if they have appropriate permissions from the administrator.

It will be further understood that because of the diversity of computing systems that may connect to the Internet service, the intermediation policy may be applied to the Internet service, rather than requiring the intermediation policy to affect each computing system individually, such as an intermediation policy application resident on each computing system, although, in various exemplary embodiments an intermediation policy may also reside on one or more of the computing systems or user devices.

Exemplary user devices for use with the disclosed systems may have an app. As used herein, an app shall be defined as a module including a user interface to an Internet service. The app may further include one or modules included in the Internet service. An app may be downloaded and installed on a user's computing device, including mobile devices. Users may define mediation policy via a user device, such as through the user interface. Some embodiments of the present invention do not require software to be downloaded or installed locally to the user device and, accordingly, do not require the user to execute a de-install application to cease use of the system.

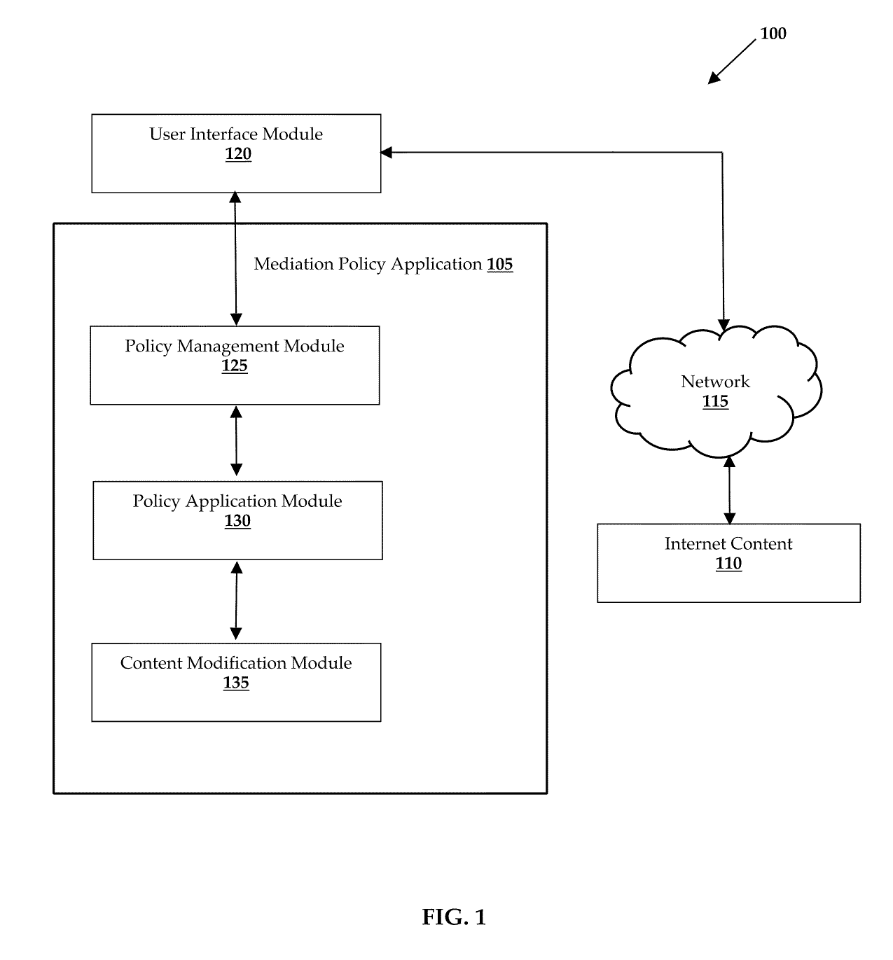

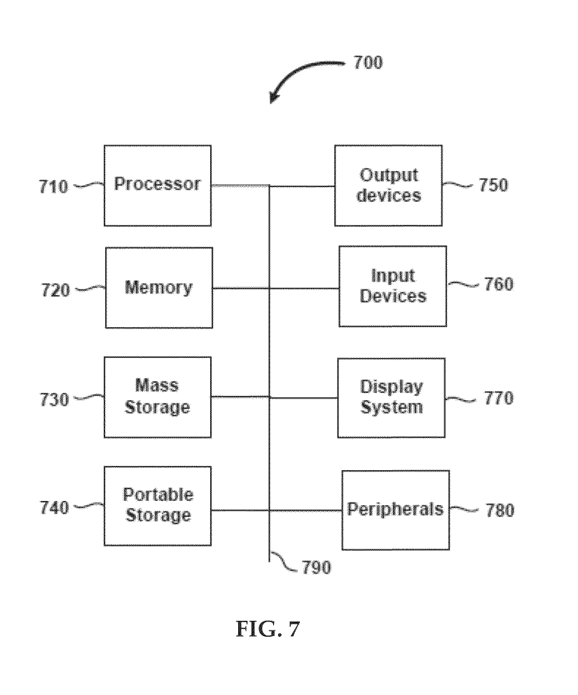

Referring now to FIG. 1, an exemplary architecture 100 of an exemplary intermediation policy application 105 resident on the computing system (described in greater detail in FIG. 7 as computing system 700) is shown. The computing system 700 may access the Internet content 110 by way of a common Internet connection (not shown) operatively coupling each computing system 700 to the Internet content 110. Common types of Internet connections include cable and DSL modems, and the like.

The computing system 700 may access Internet content 110 via network 115 (by way of the Internet connection) utilizing user interfaces generated by the user interface module 120. Generally speaking, the intermediation policy application 105 allows an administrator to create and apply a customized intermediation policy that includes information indicative of targeted Internet content that the administrator desires to prevent end users from accessing.

It is important to note that the intermediation policy application 105 does not simply provide blocking mechanisms by masking or enabling network controls, but rather mediates an Internet service. As used herein, mediating the Internet service may include any of modifying, blocking, constraining, enabling, redirecting, promoting, demoting, substituting, obscuring, limiting, interrupting, and restricting all or a portion of the Internet service, particularly targeted Internet content 110.

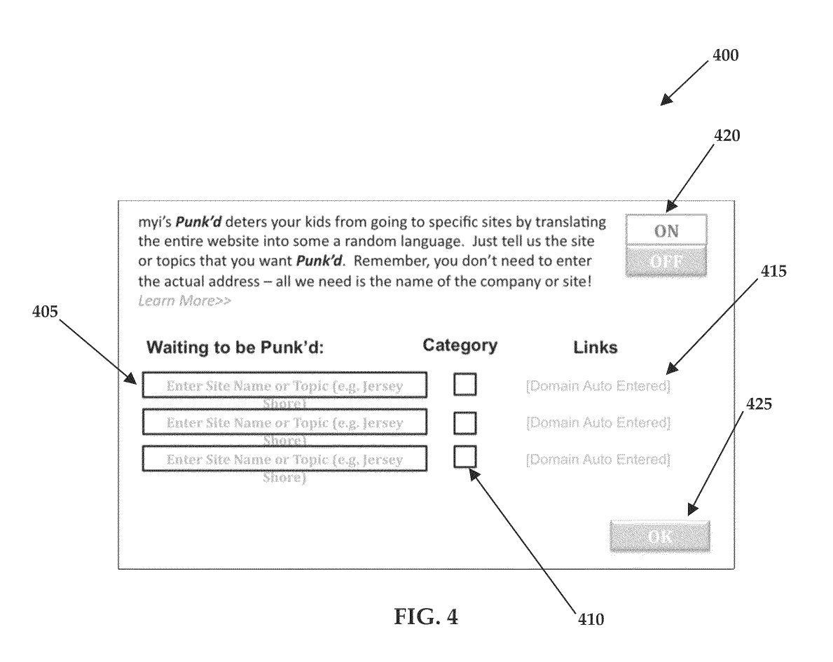

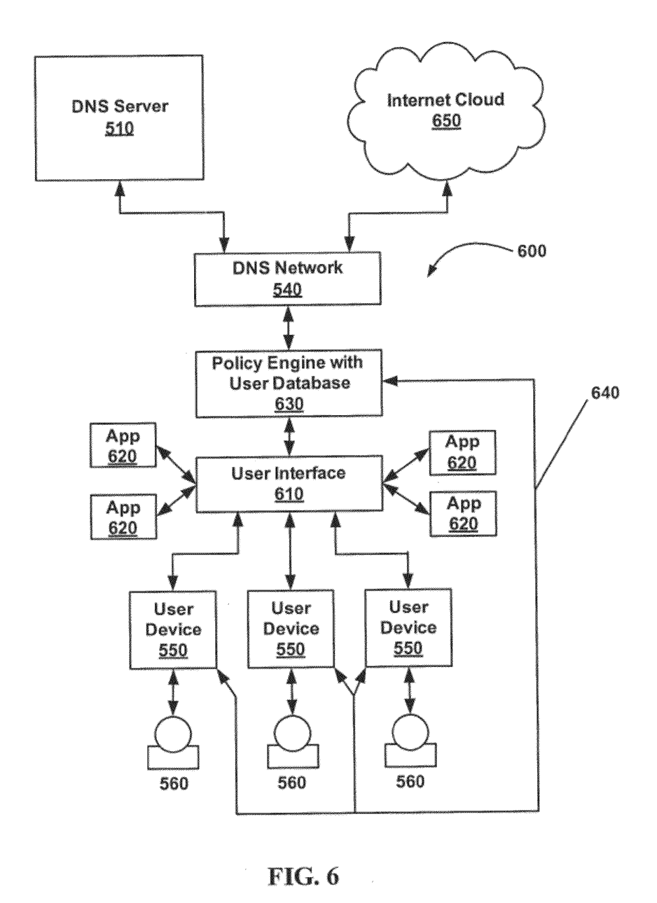

According to exemplary embodiments, the intermediation policy application 105 allows for the creation of intermediation polices via a user interface 610 such as a web page. A user interface module 120 may generate the user interface 610 (see FIG. 6). The user interface 610 may be implemented in many embodiments, although in various exemplary implementations, the user interface 610 includes web page 400 adapted to receive input from an administrator that is utilized by the intermediation policy application 105 to create and maintain one or more intermediation policies, as illustrated in FIG. 4.

According to exemplary embodiments, the intermediation policy application 105 may include a policy management module 125, a policy application module 130, and a content modification module 135. It is noteworthy that the intermediation policy application 105 may include more or fewer modules and engines (or combinations of the same) and still fall within the scope of the present technology.

In general, the intermediation policy application 105 allows administrators to create intermediation policies via the policy management module 125. The intermediation policies are applied to the Internet service by the policy application module 130 and enforced by execution of the content modification module 130. It will be understood that the content modification module 135 may modify at least a portion of targeted Internet content 110 upon an attempt by an end user to access targeted Internet content 110.

To create an intermediation policy, the policy management module 125 may execute the user interface module 120 to create a web page 400 that is adapted to receiving information indicative of targeted Internet content 110 that the administrator desires to prevent end users from accessing (FIG. 4). The web page 400 may include a plurality of input devices for receiving information indicative of targeted Internet content 110.

By way of non-limiting example, the administrator may desire to intervene when end users attempt to access particular domains that contain objectionable material. As such, the administrator may input the domain name (e.g., “www.targetedsite.com”) of a domain, if known. Additionally, the administrator may enter only the name of the domain (e.g., “Targeted Site” or “The Targeted Site”) or a topic identifier. If the administrator enters a name of a domain, the policy management module 125 may evaluate the name to determine if there are one or more domains that correspond to the name. If there is only one domain that corresponds to the name, the policy management module 125 may automatically include information indicative of the evaluated domain in the intermediation policy. In contrast, if the administrator inputs a topic identifier (e.g., “Online gambling”), the policy management module 125 is adapted to locate Internet content 110 corresponding to the topic identifier. Information indicative of the located Internet content 110 is then included in the intermediation policy. According to some embodiments, the policy management module 125 may be adapted to cause the user interface module 120 to display identifying information (e.g., domain name, application name, etc.) corresponding to the located Internet content 110. The administrator may review the identifying information to ensure that the located Internet content 110 corresponds to the topic identifier input by the administrator.

The intermediation policy may be stored in the form of a user record that resides on one or more servers located within Internet cloud 650. The administrator may modify the intermediation policy at any time by inputting additional information indicative of targeted Internet content via the web page 400. Once established, access to the configuration of the intermediation policy may be password protected to prevent end users from modifying or preventing application of the intermediation policy to the Internet service.

The intermediation policy may be applied to the Internet service via execution of the policy application module 130. It will be understood that one or more intermediation policies may be applied by the policy application module 130 to the Internet service in a granular or end user-specific manner, rather than universal manner that applies to all end users.

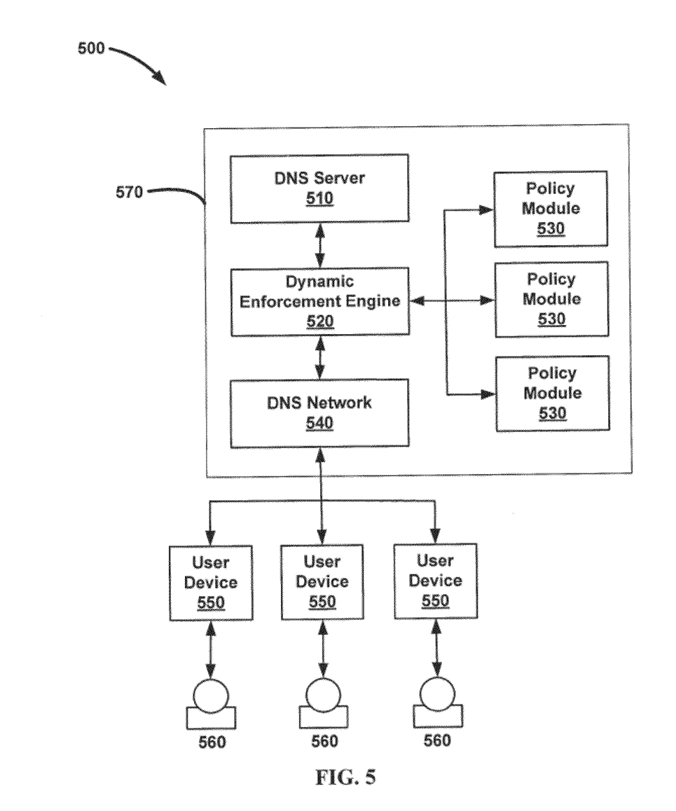

Application and enforcement of the intermediation policy includes the policy application module 130 applying the intermediation policy to the Internet service. A dynamic enforcement engine 520 (FIG. 5) evaluates requests to access Internet content 110 received from a computing system operatively coupled to the Internet service via the Internet connection. If the request corresponds to information indicative of targeted Internet content 110 included the intermediation policy, the dynamic enforcement engine 520 causes the content modification module 135 to modify at least a portion of the targeted Internet content 110.

According to exemplary embodiments, the content modification module 135 is adapted to translate at least a portion of the text of a domain from a first language to a second language. It will be understood that the content modification module 135 may include commonly utilized machine translation or statistical machine translation programs that would be known to one or ordinary skill in the art with the present disclosure before them.

More specifically, the content modification module 135 may be adapted to extract at least a portion of the textual content from the targeted Internet content 110. Once extracted, the content modification module 135 may determine a first language of the extracted textual content. The content modification module 135 may translate the extracted textual content from the first language to a second language and generate modified Internet content having the translated textual content. It will be understood that if the targeted Internet content 110 includes textual content of more than one language, each group (e.g., block, paragraph, etc.) of textual content may be translated into another language.

In some implementations (such as with web pages), the content modification module 135 may be adapted to preserve the format of the targeted Internet content 110, such that the translated textual content is placed into the modified Internet content 110 in such a way that the modified Internet content appears structurally identical to the targeted Internet content 110. For example, the targeted Internet content 110 may include structural features such as frames, text, images, links, menus, and the like. Each of these structural features may be identified by one or more vertical and horizontal coordinates relative to the web page. Utilizing these coordinates, the content modification module 135 may extract textual content from the original web page and replace the original textual content with the translated textual content in approximately the same location. Therefore, the content modification module 135 is capable of generating modified Internet content that appears to be substantially aesthetically identical to the targeted Internet content 110 but includes the translated textual content.

While it has been disclosed that the content modification module 135 is adapted to translate at least a portion of the textual content of a domain from a first language to a second language, it will be understood that the content modification module 135 may be adapted to modify the targeted Internet content 110 in a variety of other ways such as changing text to symbols, changing text to images, transposing individual letters within words, adding and/or deleting text, or transposing words within sentences, and the like.

It will be understood that the content modification module 135 may be resident and executable on a DNS server 510 (FIG. 5).

The administrator, via utilization of the user interface 610, may terminate application of the intermediation policy to the Internet service at any time. The user interface 610 may include a button (such as an enable/disable button 420 of exemplary FIG. 4) or a check box that can be toggled by the administrator to enable/disable the application of the intermediation policy to the Internet service.

According to other embodiments, a database may be used by the policy management module 125 to record and to notify administrators of various data relative to Internet access. The data collected from and provided to the administrators may include records of specific instances when targeted Internet content 110 was modified by the content modification module 135. Additionally, the policy management module 125 may record an aggregate number of times targeted Internet content 110 was modified within a predetermined amount of time. The data collected may be organized into logs that can be stored in a user record and accessed by the user interface module 120. More specifically, the user interface module 120 may generate a report (not shown), including log data indicative of the date and time resolutions of Internet content 110 were modified along with information indicative of the targeted Internet content 110.

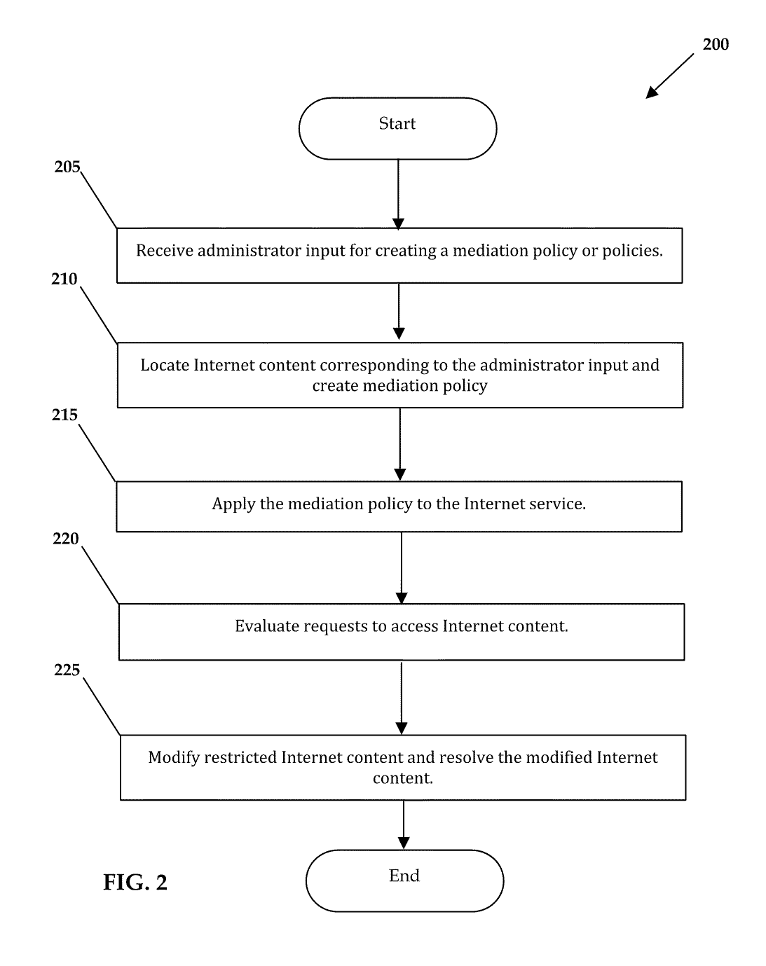

Referring now to FIG. 2, a method 200 for mediating the delivery of Internet service is shown. The method 200 begins with a step 205 of an administrator creating an intermediation policy for end users utilizing computing systems operatively coupled to the Internet service by an Internet connection. The administrator supplies input via a user interface generated by the user interface module and displayed on the computing system. For example, the user interface may display a variety of input fields to the administrator. One or more messages may be displayed on the user interface to elicit input from the administrator. The user interface may then receive from the administrator information indicative of targeted Internet content the administrator desires to prevent end users from accessing.

Input received by the user interface may be utilized by the policy management module to create an intermediation policy for one or more end users. For example, the administrator may input one or more domain names corresponding to domains that the administrator desires to prevent end users from accessing.

A subsequent step 210 includes the policy management module locating Internet content associated with the input received from the administrator. The policy management module then adds information indicative of the located Internet content to the intermediation policy.

In an additional step 215, the administrator may enable/disable selective application of the intermediation policy to the Internet service. The administrator may enable/disable the selective application of the intermediation policy via a button located on a user interface (such as the enable/disable button 420 of exemplary FIG. 4). If the administrator does not enable the intermediation policy, the method 200 terminates.

The method 200 also includes the step 220 of evaluating requests to access (e.g., resolve) Internet content. More specifically, each application of an intermediation policy begins with an end user inputting a request to access Internet content. The end user may input this request via a browser operating on the user device. In various embodiments, a request includes clicking a hyperlink located on a web page.

If the request corresponds to information indicative of targeted Internet content included in the intermediation policy, the dynamic enforcement engine causes the content modification module to modify at least a portion of the targeted Internet content in step 225. More specifically, the content modification module extracts at least a portion of textual content from the targeted Internet content and determines a first language of the extracted textual content. The content modification module may then translate the extracted textual content from the first language to a second language and generate modified Internet content having the textual content that was translated into the second language by the content modification module.

The modified Internet content is then provided to the end user via the user device. It will be understood that the method terminates after resolution of the Internet content.

In contrast, if the policy application module determines that the request does not correspond to information indicative of targeted Internet content included in the intermediation policy, the dynamic enforcement engine permits resolution of the Internet content. The Internet content is then provided by the Internet service to the end user via the user device. It will be understood that the method terminates after resolution of the Internet content.

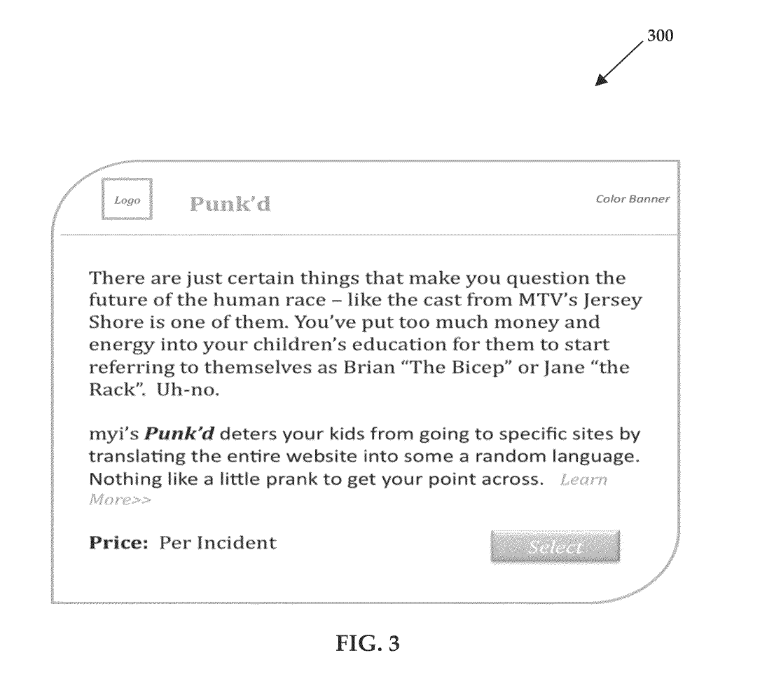

FIG. 3 illustrates an exemplary web page 300 for subscribing to the intermediation policy application. The web page may include (i) content describing the functionality of the application; (ii) the name of the application; (iii) a link to more detailed information; and (iv) a price description.

FIG. 4 illustrates an exemplary user interface, which in this instance includes a web page 400 in the form of a configuration drawer by which a plurality of input devices may be configured to receive input from an administrator. The web page 400 includes a plurality of text input boxes 405 that are adapted to receive information indicative of targeted Internet content the administrator desires to prevent end users from accessing. It will be understood that if the administrator input is indicative of a topic rather than a particular domain or application, the administrator may select a checkbox 410 disposed adjacent a corresponding text input box 405. Selecting the checkbox 410 causes the policy management module to locate available Internet content corresponding to the topic. The located Internet content may be displayed adjacent the checkbox 410 as text lines 415.

An enable/disable button(s) 420 is included, allowing an administrator to selectively control application of the intermediation policy by enabling/disabling the functionality of the intermediation policy application. Once the administrator is finished inputting information of the intermediation policy, the administrator may utilize button 425 to close the web page 400.

The systems and methods described above may typically be resident in an Internet service or a DNS network. The systems and methods described may also be implemented in plug-in utilities, gateway devices, cable modems, proxy servers, set top boxes, and network interface devices.

FIG. 5 illustrates an exemplary Internet service system 500, with a DNS server, that may be utilized to support the above described systems and methods. A DNS server 510 operates in conjunction with a dynamic enforcement engine 520. The dynamic enforcement engine 520 may operate in conjunction with one or more policy modules 530 to establish any applicable polices at the DNS level. The content rules are applied to received user queries, and determine the content that is delivered by the DNS network 540 through various user devices 550 to the end users 560.

The dynamic enforcement engine 520 may generate its policy engine on instructions received from one or more policy modules 530. Each policy module 530 may be constructed to provide various types and levels of services to the DNS network 540. In various embodiments, a policy module 530 may be configured to handle queries directed to subjects including, but not limited to, malicious domain redirection, user access redirection, non-existent domain redirection, and data collection or analysis.

It will be recognized by those skilled in the art that the elements of DNS service 570 may be hosted either locally or remotely. In addition to residing in the DNS service 570, one or more of the DNS network 540, the dynamic enforcement engine 520, and the policy modules 530, and any combination thereof, may be resident on one or more user devices 550.

FIG. 6 shows a schematic layout of an exemplary system 600 for implementing direct and variable end user control. FIG. 6 illustrates that the system 600 may operate installed on a DNS server 510, or with a cloud 650 based installation.

The system 600 utilizes a user interface 610. The user interface 610 may be implemented in many embodiments. One specific implementation of the user interface 610 is as a web page.

The user interface 610 may be accessed by one or more user devices 550 operated by the users 560. The user interface 610 may be accessed though a gateway user device 550 available to the users 560. Suitable user devices 550 include but are not limited to desktops, PCs, laptops, notebooks, gaming devices, IPods, Smartphones, automobile computer systems, and Internet enabled TVs. The system 600 may also be accessed and controlled through remote control user devices 550, such as a Smartphone. A Smartphone may be defined as a phone with computing capability. A Smartphone may provide the user 560 with Internet access.

The user interface 610 provides a mechanism for one or more authorized users 560 to establish content policy for the Internet service. The user interface 610 operates between the user devices 550 present in the system 600 and the DNS network 540. Instructions resident on the user interface 610 therefore operate on the Internet service, by controlling at least a portion of DNS resolutions via a dynamic policy engine 630, before the service reaches the displays of the user devices 550.

The user interface 610 provides the users 560 with access to one or more policy applications 620. The user interface 610 may provide access to a selection list to at least one authorized user 560. The authorized user 560 uses the selection list or some other menu mechanism to select those policy applications 620 that the user 560 chooses to apply to the system 600. The authorized user 560 may select any number of the available policy applications for use on the system 600 at any given time. In implementations utilizing smartphones as the user device 550, the policy applications 620 are downloaded to the device 550. The device 550 then serves as the user interface 610 to communicate directly with the dynamic policy engine 630.

The policy applications 620 may prohibit access to specific sites. The policy applications 620 may also limit the time of day when users or selected users 560 may access certain sites. The policy applications 620 may also manage and analyze duration of access to various sites. It is important to note that the policy applications 620 do not simply provide blocking mechanisms by masking or enabling network controls, but rather mediate an Internet service received by the end user. As used herein, mediating the service may include any of blocking, constraining, enabling, redirecting, promoting, demoting, substituting, obscuring, limiting, interrupting, and restricting all or a portion of the Internet service. The policy applications 620 may provide notifications or alerts to one or more users 560 when sites are accessed. The policy applications 620 may also provide notification of frequency and duration of access of designated sites. The policy applications 620 may also be used to observe, substitute, enable, redirect users, to reward behavior desired from the users by a system administrator, etc. The policy applications 620 may redirect users from a non-favored site to another site. The policy applications 620 may also collect and transmit data characteristic of Internet use.

Access policies supplied by the policy applications 620 may apply to all users 560 of the system 600, or the access policies may be specific to individual users or groups of users 560. The policy applications 620 may be discrete, single purpose applications. The exemplary system may be a stand-alone application or be provided as part of a system of one or more policy applications (including but not limited to a notification policy application) that allow administrator to selectively determine the specific portion of the Internet received or accessed by an end user, including any end user within a network, with all end users being monitored by the system. The policy applications may be discrete applications and may be single purpose applications. The applications may be configured to meet the needs, rules and behaviours desired by the administrator user. The administrator user may select one or more policy applications from a selection menu to provide an individualized Internet experience for the end user or his household.

The policy applications 620 provide the users 550 with a mechanism to take various actions relative to their Internet service feed. The policy applications 620 also allow the users 550 to establish a dynamic policy engine 630 that includes a user database. The policy engine 630 is used to enforce rules associated with each policy application associated with individual end users, not simply block various inappropriate sites from the Internet feed. Rather, the dynamic policy engine 630, controlled by the user interface 610 through user device(s) 550, is used to manage all aspects of the Internet experience for the users 560. In sum, the policy applications 620 may be used to configure the dynamic policy engine 630 to provide the users 560 with a mechanism to personalize the Internet experience. The policy applications 620 may be configured in combinations, and may each be separately configured.

The database in the policy engine 630 may be used to record and to notify users 560 of various data relative to Internet access. The data collected from and provided to the users 560 may include records of access of specific sites, time spent on specific sites, time of day of access, data specific to individual users, etc.

It should also be noted that following an initial setup through the user interface 610 of the policy engine 630, a direct access 640 enforcement loop may be established between the policy engine 630 and the user devices 550. Subsequent accessing of the DNS network 540 utilizing the direct access 640 decreases response time in the system 600, thereby further enhancing the Internet experience of the users 560. Configurations of policy applications 620 that are selected by one or more users 560 designated as system administrators may remain in the user database of the policy engine 630 until such time as it may be modified by the system administrators. The system administrators may define multiple policy configurations, with a combination of policy applications 620, applicable to one or more end users 560 of the system 600. Each policy application 620 may be separately configurable as well. Policy configurations may vary based upon designated times, conditional triggers, or specific requests from the users 560 with administrative authority.

As indicated above, two discrete data flow paths may be established for the system 600. A first data path establishes a set of enforcement policies for the system 600. The first data path flows from at least one user device 550 through the user interface 610, to the policy enforcement engine 630. A second data path 640 may be utilized following the establishment of a set of policies for the system 600. The second data path 640 flows directly between the user device(s) 550 and the policy engine 630. Multiple sets of enforcement policies may be established and saved within the system 600 and implemented selectively by the users 560.

FIG. 7 illustrates an exemplary computing system 700 that may be used to implement an embodiment of the present invention. System 700 of FIG. 7 may be implemented in the context of user devices 550, DNS server 510, Internet cloud 650 and the like. The computing system 700 of FIG. 7 includes one or more processors 710 and memory 720. Main memory 720 stores, in part, instructions and data for execution by processor 710. Main memory 720 can store the executable code when the system 700 is in operation. The system 700 of FIG. 7 may further include a mass storage device 730, portable storage medium drive(s) 740, output devices 750, user input devices 760, a graphics display 740, and other peripheral devices 780.

The components shown in FIG. 7 are depicted as being connected via a single bus 790. The components may be connected through one or more data transport means. Processor unit 710 and main memory 720 may be connected via a local microprocessor bus, and the mass storage device 730, peripheral device(s) 780, portable storage device 740, and display system 770 may be connected via one or more input/output (I/O) buses.

Mass storage device 730, which may be implemented with a magnetic disk drive or an optical disk drive, is a non-volatile storage device for storing data and instructions for use by processor unit 710. Mass storage device 730 can store the system software for implementing embodiments of the present invention for purposes of loading that software into main memory 710.

Portable storage device 740 operates in conjunction with a portable non-volatile storage medium, such as a floppy disk, compact disk or Digital video disc, to input and output data and code to and from the computer system 700 of FIG. 7. The system software for implementing embodiments of the present invention may be stored on such a portable medium and input to the computer system 700 via the portable storage device 740.

Input devices 760 provide a portion of a user interface. Input devices 760 may include an alphanumeric keypad, such as a keyboard, for inputting alphanumeric and other information, or a pointing device, such as a mouse, a trackball, stylus, or cursor direction keys. Additionally, the system 700 as shown in FIG. 7 includes output devices 750. Suitable output devices include speakers, printers, network interfaces, and monitors.

Display system 770 may include a liquid crystal display (LCD) or other suitable display device. Display system 770 receives textual and graphical information, and processes the information for output to the display device.

Peripherals 780 may include any type of computer support device to add additional functionality to the computer system. Peripheral device(s) 780 may include a modem or a router.

The components contained in the computer system 700 of FIG. 7 are those typically found in computer systems that may be suitable for use with embodiments of the present invention and are intended to represent a broad category of such computer components that are well known in the art. Thus, the computer system 700 of FIG. 7 can be a personal computer, hand held computing system, telephone, mobile computing system, workstation, server, minicomputer, mainframe computer, or any other computing system. The computer can also include different bus configurations, networked platforms, multi-processor platforms, etc. Various operating systems can be used including UNIX, Linux, Windows, Macintosh OS, Palm OS, and other suitable operating systems.

Some of the above-described functions may comprise instructions that are stored on storage media (e.g., computer-readable medium). The instructions may be retrieved and executed by the processor. Some examples of storage media are memory devices, tapes, disks, and the like. The instructions are operational when executed by the processor to direct the processor to operate in accord with the invention. Those skilled in the art are familiar with instructions, processor(s), and storage media.

Any hardware platform suitable for performing the processing described herein is suitable for use with the invention. The terms “computer-readable storage medium” and “computer-readable storage media” as used herein refer to any medium or media that participate in providing instructions to a CPU for execution. Such media may take many forms, including, but not limited to, non-volatile media, volatile media and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one embodiment of a bus. Transmission media may also take the form of acoustic or light waves, such as those generated during radio frequency (RF) and infrared (IR) data communications. Common forms of computer-readable media include, for example, a floppy disk, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASHEPROM, any other memory chip or cartridge, a carrier wave, or any other medium from which a computer may read.

The systems and methods described above may typically be resident in an Internet service or a DNS network. For instance, although this description describes the technology in the context of a DNS server, it will be appreciated by those skilled in the art that an Internet service provider may be utilized with this invention instead or in conjunction with a DNS server. Functionalities and method steps that are performed by a DNS server may be performed by an Internet service provider. Furthermore, one skilled in the art will appreciate that the term “Internet content” encompasses any content that may be accessed by an Internet access user device which include domains, web pages, web addresses, one or more hyperlinks, URLs, any text, pictures, and/or media (such as video, audio, and any combination of audio and video) provided or displayed on a web page, and any combination thereof.

The systems and methods described may also be implemented in plug-in utilities, gateway devices, cable modems, proxy servers, set top boxes, and network interface devices. Further, as will be appreciated by those of ordinary skill in the art, the embodiments presented herein may be implemented on any form of Internet service, including, but not limited to, Broadband wireless access, including Mobile Communications (GSM) and Code Division Multiple Access (CDMA) systems, Cable Internet, Dial-up, ISDN, Modem, DSL, FTTH, Wi-Fi, DSL, Ethernet technologies, and SHDSL services, as well as others.

The above description is illustrative and not restrictive. Many variations of the invention will become apparent to those of skill in the art upon review of this disclosure. The scope of the invention should, therefore, be determined not with reference to the above description, but instead should be determined with reference to the appended claims along with their full scope of equivalents. While the present invention has been described in connection with a series of embodiments, these descriptions are not intended to limit the scope of the invention to the particular forms set forth herein. It will be further understood that the methods of the invention are not necessarily limited to the discrete steps or the order of the steps described. To the contrary, the present descriptions are intended to cover such alternatives, modifications, and equivalents as may be included within the spirit and scope of the invention as defined by the appended claims and otherwise appreciated by one of ordinary skill in the art. For example, this description describes the technology in the context of an Internet service in conjunction with a DNS server. It will be appreciated by those skilled in the art that functionalities and method steps that are performed by a DNS server may be performed by an Internet service.

One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the invention as described herein.

One skilled in the art will further appreciate that the term “Internet content” comprises one or more of web sites, domains, web pages, web addresses, hyperlinks, URLs, any text, pictures, and/or media (such as video, audio, and any combination of audio and video) provided or displayed on a web page, and any combination thereof.

While specific embodiments of, and examples for, the system are described above for illustrative purposes, various equivalent modifications are possible within the scope of the system, as those skilled in the relevant art will recognize. For example, while processes or steps are presented in a given order, alternative embodiments may perform routines having steps in a different order, and some processes or steps may be deleted, moved, added, subdivided, combined, and/or modified to provide alternative or subcombinations. Each of these processes or steps may be implemented in a variety of different ways. Also, while processes or steps are at times shown as being performed in series, these processes or steps may instead be performed in parallel, or may be performed at different times.

From the foregoing, it will be appreciated that specific embodiments of the system have been described herein for purposes of illustration, but that various modifications may be made without deviating from the spirit and scope of the system. Accordingly, the disclosure is not limited except as by the appended claims.

What is claimed is:

1. A method for mediating the delivery of an Internet service, the method comprising:
selectively applying an intermediation policy to the Internet service in response to a query from a user, the intermediation policy including information indicative of targeted Internet content; and
modifying at least a portion of targeted Internet content before delivery of the targeted Internet content, and delivering the modified Internet content via the Internet service so that the user is made aware of the intermediation policy.

2. The method according to claim 1, further comprising creating an intermediation policy by:
receiving information indicative of targeted Internet content; and
including the received information in the intermediation policy.

3. The method according to claim 2, wherein after the step of receiving but before the step of including, the method comprising:
locating Internet content corresponding to the received information;
displaying identifiers associated with the corresponding Internet content; and
selecting at least one identifier.

4. The method according to claim 1, wherein modify includes translating at least a portion of the targeted Internet content from a first language to a second language or substituting text within the targeted internet content.

5. The method according to claim 1, wherein the intermediation policy is specific to a single user.

6. The method according to claim 1, wherein modify includes:
extracting at least a portion of textual content from the targeted Internet content;
determining a first language of the extracted textual content;
translating the extracted textual content from the first language to a second language; and
generating modified Internet content that includes the textual content translated into the second language.

7. The method according to claim 6, wherein generating includes preserving the format of the targeted Internet content and exchanging the extracted textual content with the textual content translated into the second language.

8. The method according to claim 1, wherein selectively apply the intermediation policy to the Internet service includes:
receiving a request to access Internet content from a user device coupled to the Internet service;
comparing the request to the intermediation policy; and
modifying a resolution performed by a DNS server if the request corresponds to information indicative of targeted Internet content is included the intermediation policy, wherein modifying includes translating at least a portion of the content of the Internet content from a first language to a second language.

9. The method according to claim 8, wherein modifying includes modifying a resolution performed by an Internet service provider if the request corresponds to information indicative of targeted Internet content is included the intermediation policy, wherein modifying includes translating at least a portion of the content of the Internet content from a first language to a second language.

10. The method according to claim 1, wherein the targeted Internet content includes any of a domain, a video, audio, and an application.

11. The method of claim 1, wherein modified includes substituting at least a portion of Internet content of the targeted Internet content with new images, text or video.

12. The method of claim 1, wherein at least a portion of the intermediation policy is resident on the DNS server.

13. The method of claim 1, wherein at least a portion of the intermediation policy is enforced by the DNS server.

14. The method of claim 1, wherein at least a portion of the Internet service is resident on a user device.

15. A system for mediating the delivery of an Internet service, the system comprising:
a memory for storing an intermediation policy application; and
a processor for executing the intermediation policy application that:
selectively applies an intermediation policy to the Internet service in response to a query from a user, the intermediation policy including information indicative of targeted Internet content; and
modifies at least a portion of targeted Internet content before delivery of the targeted Internet content, and delivering the modified Internet content via the Internet service so that the user is made aware of the intermediation policy.

16. The system according to claim 15, wherein the intermediation policy application comprises a policy management module stored in memory and executable by the processor to create the intermediation policy by:
receiving information indicative of Internet content; and
including the received information in the intermediation policy.

17. The system according to claim 16, wherein the intermediation policy application is adapted to:
locate Internet content corresponding to the received information;
display at least one identifying information corresponding to the located Internet content; and
receive at least one information indicative of a selection of the at least one identifying information.

18. The system according to claim 15, wherein the intermediation policy application comprises a content modification module stored in memory and executable by the processor to translate at least a portion of the targeted Internet content from a first language to a second language.

19. The system according to claim 16, wherein the intermediation policy application comprises a content modification module stored in memory and executable by the processor to translate at least a portion of the targeted Internet content from a first language to a second language and third language.

20. The system according to claim 16, wherein the intermediation policy application comprises a content modification module stored in memory and executable by the processor to:
extract at least a portion of textual content from the targeted Internet content;
determine a first language of the extracted textual content;
translate the extracted textual content from the first language to a second language; and
generate modified Internet content that includes the textual content translated into the second language.

21. The system according to claim 20, wherein the content modification module is adapted to preserve the format of the targeted Internet content and exchange the extracted textual content with the textual content translated into the second language.

22. The system according to claim 21, wherein the intermediation policy application comprises a policy application module stored in memory and executable by the processor to:
receive a request to access Internet content from a user device coupled to the Internet service;
compare the requested Internet content to the intermediation policy; and
cause the content modification module to modify a resolution performed by a DNS server if the request corresponds to information indicative of targeted Internet content is included the intermediation policy, wherein modify includes translating at least a portion of the content of the targeted Internet content from a first language to a second language.

23. The system according to claim 22, wherein the policy application module is adapted to cause the content modification module to modify a resolution performed by an Internet service if the request corresponds to information indicative of targeted Internet content is included the intermediation policy, wherein modify includes translating at least a portion of the content of the targeted Internet content from a first language to a second language.

24. The system according to claim 15, wherein the targeted Internet content includes any of a domain, a video, audio, and an application.

25. The system according to claim 15, wherein modified includes substituting at least a portion of Internet content of the targeted Internet content with new images, text or video.

26. The system according to claim 15, wherein at least a portion of the intermediation policy is resident on the DNS server.

27. The system according to claim 15, wherein at least a portion of the intermediation policy is enforced by the DNS server.

28. The system according to claim 15, wherein a portion of the Internet service is resident on a user device.

29. A non-transitory computer readable storage medium having a program embodied thereon, the program executable by a processor in a computing system to perform a method for mediating the delivery of an Internet service, the method comprising:
executing instructions stored in a memory by a processor to:
selectively apply an intermediation policy to the Internet service in response to a query from a user, the intermediation policy including information indicative of targeted Internet content; and
modify at least a portion of targeted Internet content before delivery of the targeted Internet content via the Internet service so that the user is made aware that the query is for targeted Internet content.

30. The non-transitory computer readable storage medium according to claim 29, wherein the intermediation policy application comprises a policy management module stored in memory and executable by the processor to create an intermediation policy by:
receiving information indicative of targeted Internet content; and
including the received information in the intermediation policy.

31. The non-transitory computer readable storage medium according to claim 30, wherein after the step of receiving but before the step of including, the method comprising:
locating Internet content corresponding to the received information;
displaying at least one identifying information corresponding to the located Internet content; and
receiving at least one selection indicative of a selection of the at least one identifying information.

32. The non-transitory computer readable storage medium according to claim 29, wherein modify includes:
extracting at least a portion of textual content from the targeted Internet content;
determining a first language of the extracted textual content;
translating the extracted textual content from the first language to a second language;
generating modified Internet content that includes the textual content translated into the second language; and
wherein generating includes preserving the format of the targeted Internet content and exchanging the extracted textual content with the textual content translated into the second language.

33. The non-transitory computer readable storage medium according to claim 29, wherein selectively apply the intermediation policy to the Internet service includes:
receiving a request to access Internet content from a user device coupled to the Internet service;
comparing the requested Internet content to the intermediation policy; and
modifying a resolution performed by a DNS server if the request corresponds to information indicative of targeted Internet content is included the intermediation policy, wherein modifying includes translating at least a portion of the content of the targeted Internet content from a first language to a second language.

34. The non-transitory computer readable storage medium according to claim 29, wherein modify includes modifying a resolution performed by an Internet service provider if the request corresponds to information indicative of targeted Internet content is included the intermediation policy, wherein modifying includes translating at least a portion of the content of the Internet content from a first language to a second language.

35. The non-transitory computer readable storage medium according to claim 29, wherein the targeted Internet content includes any of a domain, a video, audio, and an application.

36. A method for mediating the delivery of an Internet service, the method comprising:
selectively applying an intermediation policy to the Internet service via a DNS server in response to a query from a user, the intermediation policy including information indicative of targeted Internet content; and
modifying at least a portion of targeted Internet content before delivery of the targeted Internet content, and delivering the modified Internet content so that the user is made aware of the intermediation policy.

37. The method according to claim 28, further comprising creating an intermediation policy by:
receiving information indicative of targeted Internet content; and
including the received information in the intermediation policy.

38. The method according to claim 37, wherein after the step of receiving but before the step of including, the method comprising:
locating Internet content corresponding to the received information;
displaying identifiers associated with the corresponding Internet content; and
selecting at least one identifier.

39. The method according to claim 36, wherein modify includes translating at least a portion of the targeted Internet content from a first language to a second language.

40. The method according to claim 36, wherein the intermediation policy is specific to a single user.

41. The method according to claim 36, wherein modify includes:
extracting at least a portion of textual content from the targeted Internet content;
determining a first language of the extracted textual content;
translating the extracted textual content from the first language to a second language; and
generating modified Internet content that includes the textual content translated into the second language.

42. The method according to claim 41, wherein generating includes preserving the format of the targeted Internet content and exchanging the extracted textual content with the textual content translated into the second language.

43. The method according to claim 42, wherein selectively apply the intermediation policy to the Internet service includes:
receiving a request to access Internet content from a user device coupled to the Internet service;
comparing the request to the intermediation policy; and
modifying a resolution performed by a DNS server if the request corresponds to information indicative of targeted Internet content is included the intermediation policy, wherein modifying includes translating at least a portion of the content of the Internet content from a first language to a second language.

44. The method according to claim 43, wherein modifying includes modifying a resolution performed by an Internet service provider if the request corresponds to information indicative of targeted Internet content is included the intermediation policy, wherein modifying includes translating at least a portion of the content of the Internet content from a first language to a second language.

45. The method according to claim 36, wherein the targeted Internet content includes any of a domain, a video, audio, and an application.

46. The method of claim 36, wherein modified includes substituting at least a portion of Internet content of the targeted Internet content with new images, text or video.

47. The method of claim 36, wherein a portion of the Internet service is resident on a user device.

48. A system for mediating the delivery of an Internet service, the system comprising:
a memory for storing an intermediation policy application; and
a processor for executing the intermediation policy application that:
selectively applies the intermediation policy to the Internet service via a DNS server in response to a query from a user, the intermediation policy including information indicative of targeted Internet content; and
modifies at least a portion of targeted Internet content before delivery of the targeted Internet content, and delivering the modified Internet content via the DNS server so that the user is made aware of the intermediation policy.

49. The system according to claim 48, wherein the intermediation policy application comprises a policy management module stored in memory and executable by the processor to create an intermediation policy by:
receiving information indicative of Internet content; and
including the received information in the intermediation policy.

50. The system according to claim 49, wherein the intermediation policy application is adapted to:
locate Internet content corresponding to the received information;
display at least one identifying information corresponding to the located Internet content; and
receive at least one information indicative of a selection of the at least one identifying information.

51. The system according to claim 48, wherein the intermediation policy application comprises a content modification module stored in memory and executable by the processor to translate at least a portion of the targeted Internet content from a first language to a second language.

52. The system according to claim 49, wherein the intermediation policy application comprises a content modification module stored in memory and executable by the processor to translate at least a portion of the targeted Internet content from a first language to a second language and third language.

53. The system according to claim 49, wherein the intermediation policy application comprises a content modification module stored in memory and executable by the processor to:
extract at least a portion of textual content from the targeted Internet content;
determine a first language of the extracted textual content;
translate the extracted textual content from the first language to a second language; and
generate modified Internet content that includes the textual content translated into the second language.

54. The system according to claim 53, wherein the content modification module is adapted to preserve the format of the targeted Internet content and exchange the extracted textual content with the textual content translated into the second language.

55. The system according to claim 54, wherein the intermediation policy application comprises a policy application module stored in memory and executable by the processor to:
receive a request to access Internet content from a user device coupled to the Internet service;
compare the requested Internet content to the intermediation policy; and
cause the content modification module to modify a resolution performed by a DNS server if the request corresponds to information indicative of targeted Internet content is included the intermediation policy, wherein modify includes translating at least a portion of the content of the targeted Internet content from a first language to a second language.

56. The system according to claim 55, wherein the policy application module is adapted to cause the content modification module to modify a resolution performed by an Internet service if the request corresponds to information indicative of targeted Internet content is included the intermediation policy, wherein modify includes translating at least a portion of the content of the targeted Internet content from a first language to a second language.

57. The system according to claim 48, wherein the targeted Internet content includes any of a domain, a video, audio, and an application.

58. The system according to claim 48, wherein modified includes substituting at least a portion of Internet content of the targeted Internet content with new images, text or video.

59. The system according to claim 38, wherein at least a portion of the Internet service is resident on a user device.
